(19) United States
(12) Patent Application Publication
(10) Pub. No.: US 2007/0218897 A1
(43) Pub. Date: Sep. 20, 2007

(54) Communication device, communication system, communication method, and program

(75) Inventors: Yasumune Yukizaki, Yokosuka-city (JP); Manabu Sawada, Yokohama-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/724,650

(22) Filed: Mar. 15, 2007

(30) Foreign Application Priority Data
Mar. 20, 2006 (JP) 2006-077231

(51) Int. Cl. H04Q 7/20

(52) U.S. Cl. 455/432.1

(57) ABSTRACT

When a terminal station receives a beacon in a channel f(i), it registers a MAC address included in the beacon in a registration table with an association with the channel f(i), then registers channels in which the same MAC address is registered, and the number of the channels in the registration table. By this processing, channels usable in a base station and the number of the channels usable are designated without need of adding, to a packet, information indicating the channels usable and the number of the channels usable.

### CROSS REFERENCE TO RELATED APPLICATION

This application is based on and incorporates herein by reference Japanese Patent Application No. 2006-77231 filed on Mar. 20, 2006.

### FIELD OF THE INVENTION

The present invention relates to technology for performing communication by use of multiple channels.

### BACKGROUND OF THE INVENTION

Conventionally, dynamic channel assignment is known as a method by which a base station assigns, to individual terminal stations, channels used for communication therewith (for example, see Patent Document 1). In this dynamic channel assignment method, on receiving a connection request from a terminal station, a base station selects one channel optimum to the terminal station from among multiple channels, based on a CI ratio (Carrier to co-channel power ratio) and traffic, and assigns the selected channel to the terminal station.

Recently, as new standards of wireless LAN, IEEE802.11n is known (for example, see Non-patent Document 1).

The IEEE802.11n is standards for achieving communication of high throughput by allowing wireless LAN devices having multiple antennas to use multiple channels of a same frequency band.

The IEEE802.11 n defines a wireless LAN device as informing other wireless LAN devices of high-throughput information (HT Capability Element) to indicate usable channels and the number of the channels. This high-throughput information is stored in packets and transmitted to other wireless LAN devices.

Patent Document 1: JP-A-H5-55990

Non-patent Document 1: Syed Aon Mujtaba, “TGn Sync Proposal Technical Specification”, May 18, 2005, IEEE 802 LAN/MAN Standards Committee (Retrieved on Mar. 1, 2006 via Internet<URL: http://www.ieee802.org/11/DocFiles/05/Files%20From%20May%202005/TGn/II-04-0889-06-000n-tgnsync-proposal-technical-specification.doc>).

By the way, in the above-described dynamic channel assignment, a base station does not designate the number of channels usable in a terminal station. For this reason, even when the terminal station is constructed to use multiple channels to perform communication, the base station cannot assign the multiple channels to the terminal station. Therefore, the terminal station cannot use the multiple channels to perform communication.

On the other hand, according to the IEEE802.11n, wireless LAN devices can use multiple channels to perform communication.

However, the IEEE802.11n has a drawback in that since high-throughput information must be extra added to a packet to designate channels usable in the wireless LAN devices and the number of the channels, the packet length becomes longer accordingly, resulting in lower throughput.

### SUMMARY OF THE INVENTION

Accordingly, the present invention has been made in view of the above-described problem; its object is to provide technology for making it possible to designate usable channels and the number of the channels even when information indicating them is not added to packets.

According to an aspect of the present invention, a communication device is provided as follows. A receiving unit is configured to receive, by using multiple channels, a packet including an identifier to identify a transmitting source. An identifier registering unit is configured to register the identifier included in the packet in a pre-specified storage area such that the registered identifier is associated with a channel through which the receiving unit receives the packet. A channel designating unit is configured to designate, when the identifier is registered in the storage area, a channel, which the registered identifier is associated with, as a channel usable for communication with the transmitting source indicated by the registered identifier. A channel counting unit is configured to count, when the identifier is registered in the storage area, a number of channels, which the registered identifier is associated with, as a number of channels usable for communication with the transmitting source indicated by the registered identifier.

According to another aspect of the present invention, a communication system is provided as follows. A base station and a terminal station that transmit and receive packets to and from each other are included. Here, at least one of the base station and the terminal station includes the above described communication device.

According to yet another aspect of the present invention, a communication method is provided as follows. A packet including an identifier to identify a transmitting source is received by using multiple channels. The identifier included in the packet is registered in a pre-specified storage area such that the registered identifier is associated with a channel through which the packet is received. When the identifier is registered in the storage area, a channel, which the registered identifier is associated with, is designated as a channel usable for communication with the transmitting source indicated by the registered identifier. When the identifier is registered in the storage area, a number of channels, which the registered identifier is associated with, is counted as a number of channels usable for communication with the transmitting source indicated by the registered identifier.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing an overall construction of a communication system according to a first embodiment;

FIG. 2 is a block diagram showing an internal construction of a base station and a terminal station according to the first embodiment;

FIG. 3 is an explanatory diagram showing channel assignment of the base station and the terminal station according to the first embodiment;

FIG. 4 is a sequence diagram showing a procedure of communication performed between the base station and the terminal station according to the first embodiment;

FIG. 5 is a flowchart showing the flow of designation processing in a terminal station according to the first embodiment;

FIG. 6 is an explanatory diagram summarizing a registration table set in the terminal station according to the first embodiment;

FIG. 7 is an explanatory diagram showing changes in the registration table set in the terminal station according to the first embodiment;

FIG. 8 is a flowchart showing the flow of designation processing in a base station according to the first embodiment;

FIG. 9 is an explanatory diagram summarizing a registration table set in the base station according to the first embodiment;

FIG. 10 is an explanatory diagram showing changes in the registration table set in the base station according to the first embodiment;

FIG. 11 is a block diagram showing an overall construction of a communication system in a second embodiment;

FIG. 12 is an explanatory diagram showing channel assignment of a base station and a terminal station according to the second embodiment;

FIG. 13 is a sequence diagram showing a procedure of communication performed between the base station and the terminal station according to the second embodiment; and

FIG. 14 is an explanatory diagram showing changes in a registration table set in the base station according to the second embodiment.

### DETAILED DESCRIPTION OF THE PREFERRED EMBODIMENTS

Hereinafter, embodiments of the present invention will be described with reference to the accompanying drawings.

### First Embodiment

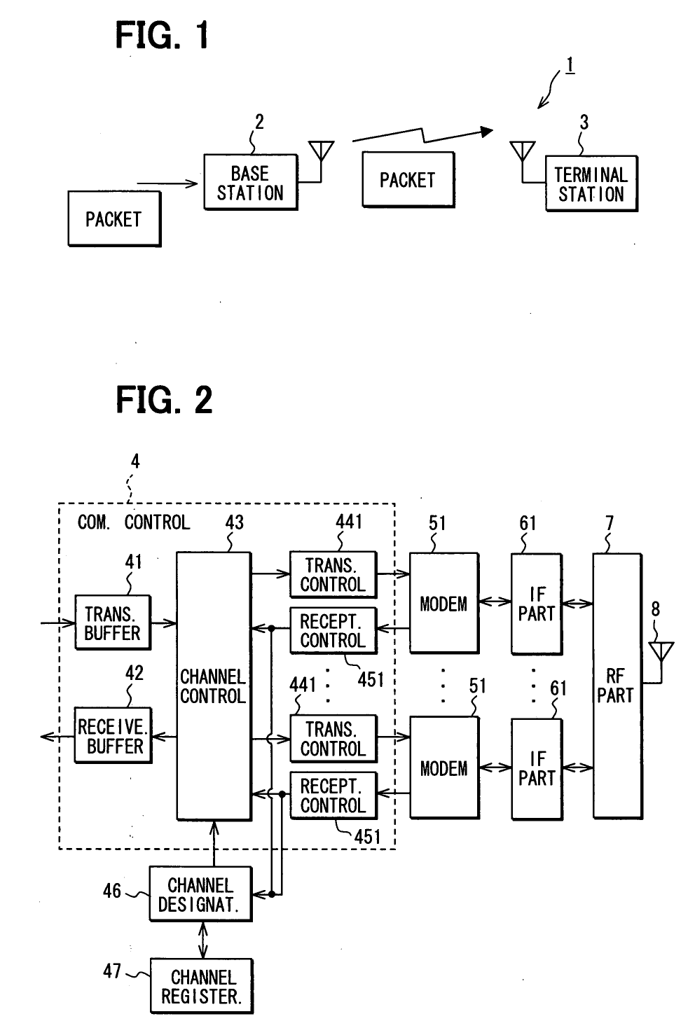

FIG. 1 is a block diagram showing an overall construction of a communication system 1 according to a first embodiment of the present invention.

As shown in FIG. 1, a communication system 1 includes a base station 2 and a terminal station 3. The base station 2 and the terminal station 3 mutually transmit and receive packets over wireless communication.

FIG. 2 is a block diagram showing an internal construction of the base station 2 and the terminal station 3; namely, the base station 2 has the internal construction similar to that of the terminal station 3.

As shown in FIG. 2, the internal construction includes one communication control part 4, multiple modems 51 respectively corresponding to multiple channels, multiple intermediate frequency signal parts 61 (IF parts) respectively corresponding to multiple channels, and one radio frequency signal part 7 (RF part).

Each of the modems 51 superimposes a packet inputted from the communication control part 4 on a career signal, and outputs it to a corresponding IF part 61. Each of the modems 51 also extracts a packet from a career signal inputted from a corresponding IF part 61, and outputs the extracted packet to the communication control part 4.

Each of the IF parts 61 converts a career signal inputted from a corresponding modem 51 into an intermediate frequency signal (IF signal), and outputs it to the RF part 7. Each of the IF parts 61 also converts an IF signal inputted from the RF part 7 into a career signal, and outputs it to a corresponding modem 51.

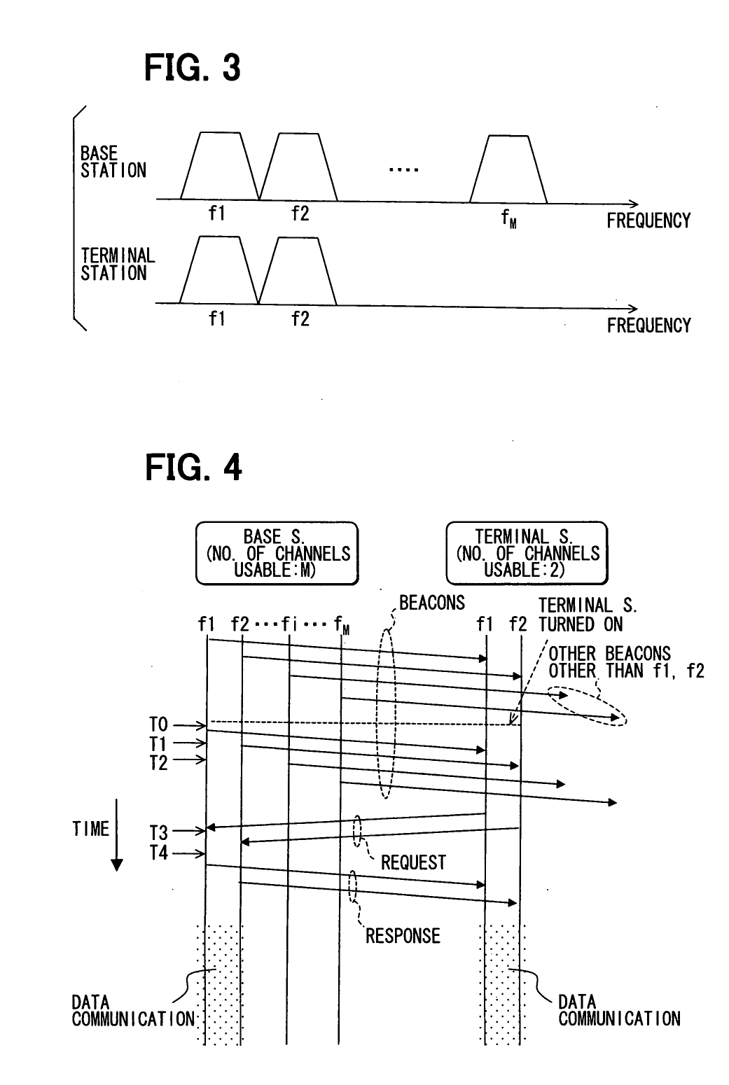

In the first embodiment, the base station 2 includes M (natural number of 3 or more) number of pairs of the modems 51 and the IF parts 61 to use M number of channels f1 to fM (see FIG. 3) having individual frequency bands that are adjacent to one another. The terminal station 3 includes two modems 51 and two IF parts 61 to use two channels f1 and f2 (see FIG. 3) having frequency bands that are adjacent to each other.

The RF part 7 converts IF signals inputted from all the IF parts 61 into radio frequency signals (RF signals), and transmits them from the antenna 8. It also converts an RF signal received in the antenna 8 into an IF signal and outputs it to each of the IF parts 61.

The communication control part 4 includes one transmission buffer 41, one receiving buffer 42, one channel controller 43, multiple transmission control parts 441 respectively corresponding to multiple channels, multiple reception control parts 451 respectively corresponding to multiple channels, one channel designating part 46, and one channel registering part 47.

The transmission buffer 41 temporarily stores packets inputted from the outside, then outputs the stored packets to the channel controller 43.

The receiving buffer 42 temporarily stores packets inputted from the channel controller 43, then outputs the stored packets to the outside.

The channel controller 43 outputs packets inputted from the transmission buffer 41 to each of the transmission control parts 441. It also outputs packets inputted from each of the reception control parts 451 to the receiving buffer 42.

Each of the transmission control parts 441 outputs packets inputted from the channel controller 43 to a corresponding modem 51.

Each of the reception control parts 451 outputs packets inputted from a corresponding modem 51 to the channel controller 43.

The base station 2 of the first embodiment includes M number of pairs of the transmission control parts 441 and the reception control parts 451. The terminal station 3 includes two transmission control parts 441 and two reception control parts 451.

The channel designating part 46 executes designation processing described later, and designates packets usable in a packet transmitting source and the number of the packets.

The channel registering part 47 registers (i) a channel in which a packet was received and (ii) a MAC (Media Access Control) address of a transmitting source included in the packet, with an association between the channel and the MAC address, i.e., the channel and the MAC address are registered while being associated with each other.

These constituting blocks described above are achieved by various electronic circuits composed of CPU, ROM, RAM, and various elements, and processing of programs executed by the CPU.

FIG. 4 is a sequence diagram showing a procedure of communication performed between the base station 2 and the terminal station 3.

As shown in FIG. 4, in the communication system 1, the base station 2 sequentially switches the channels f1 to fM, and transmits a beacon packet indicating the existence of the base station. More specifically, the MAC address, BSSID (Basic Service Set Identifier), and the like of the base station 2 are included in the beacon packet.

On the other hand, when power is applied to the terminal station 3 (time T0), it receives a beacon using the channels f1 and f2.

On receiving a beacon using the channels f1 and f2 (times T1 and T2), the terminal station 3 transmits a connection request packet to the base station 2, using the channels f1 and f2. More specifically, the connection request packet includes information indicating a connection request, the MAC address, BSSID, and the like of the terminal station 3.

On receiving the connection request using the channels f1 and f2 (times T3 and T4), the base station 2 transmits a connection response packet to the terminal station 3 in response to the connection request, using the channels f1 and f2. More specifically, the connection response packet includes information indicating a response to the connection request in addition to the MAC address, BSSID, and the like of the base station 2.

By this procedure, communication between the base station 2 and the terminal station 3 is established, and transmission and reception of data is started.

Hereinafter, of various processing performed in the base station 2 and the terminal station 3, processings relating to the present invention will be described.

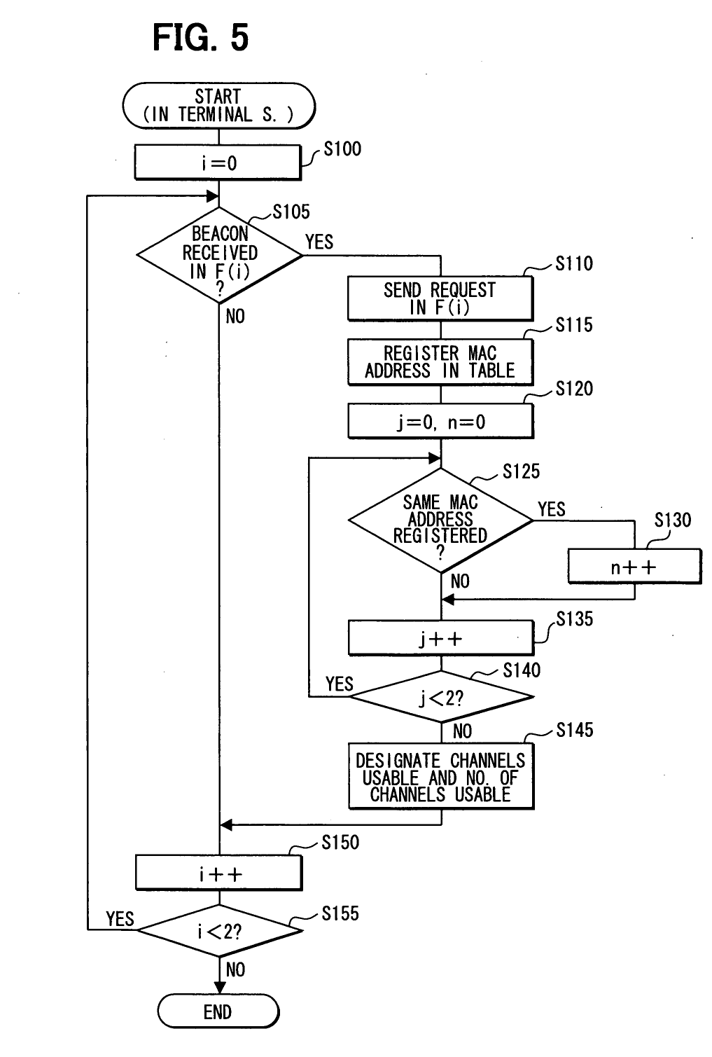

FIG. 5 is a flowchart showing the flow of designation processing (designation processing in the terminal station) performed by the channel designating part 46 of the terminal station 3. The channel designating part 46 of the terminal station 3 performs the processing when power is applied to the terminal station 3.

As shown in FIG. 5, as a first step, the processing initializes channel identification number i associated with the channels f1 and f2 to 0 (S100), selects a channel f(i) corresponding to the channel identification number i, and receives a beacon from a reception control part 451 corresponding to the channel f(i). The channel f1 is associated with a channel identification number i=0, and the channel f2 is associated with a channel identification number i=1.

The processing determines whether a beacon is received in a channel f(i) (S105), and when a beacon is not received (S105: No), immediately proceeds to S150 described later.

On the other hand, when a beacon is received in the channel f(i) (S105: Yes), the processing instructs the channel controller 43 to select the channel f(i) that received the beacon, and transmit a connection request to the base station 2, using the channel f(i) (S110).

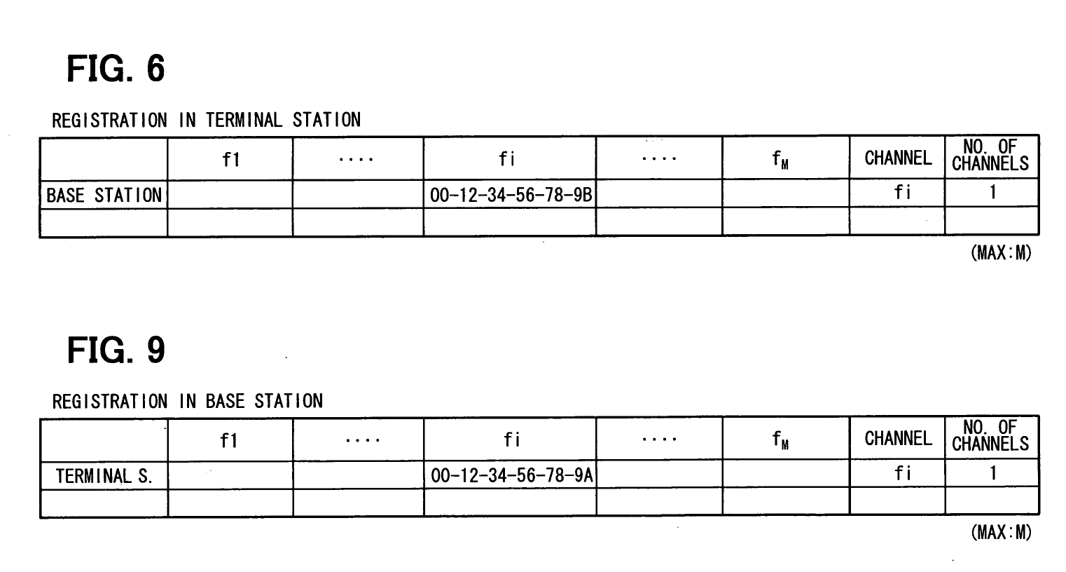

After registering a MAC address included in the beacon in a registration table (see FIG. 6) set in the channel registering part 47, with an association with the channel f(i) (S115), the processing initializes channel search number j associated with the channels f1 and f2 and a value n for counting the number of channels to 0 (S120). The channel f1 is associated with a channel search number j=0, and the channel f2 is associated with a channel search number j=1.

The processing determines whether the same MAC address as the MAC address registered in the registration table in S115 is registered in the registration table, with an association with a channel f(j) corresponding to a channel search number j (S125).

When it is not registered in the registration table (S125: No), the processing immediately proceeds to S135 described later, while when registered (S125: Yes), the processing increments the count value n by one (S130), then increments the channel search number j by one (S135).

The processing determines whether the channel search number j is smaller than the number of channels usable in the terminal station 3 (that is, the number of channels=2) (S140), and when smaller (S140: Yes), proceeds again to the above-described S125.

On the other hand, when not smaller (S140: No), by registering usable channels and the number of the channels (count value n) in the registration table with an association with the base station 2, the processing designates channels usable in the base station 2 and the number of the channels (S145).

The processing increments the channel identification number i by one (S150), determines whether the channel identification number i is smaller than the number of channels usable in the terminal station 3 (that is, the number of channels=2) (S155), and when smaller (S155: Yes), proceeds again to the above-described S105, while when not smaller (S155: No), the processing ends.

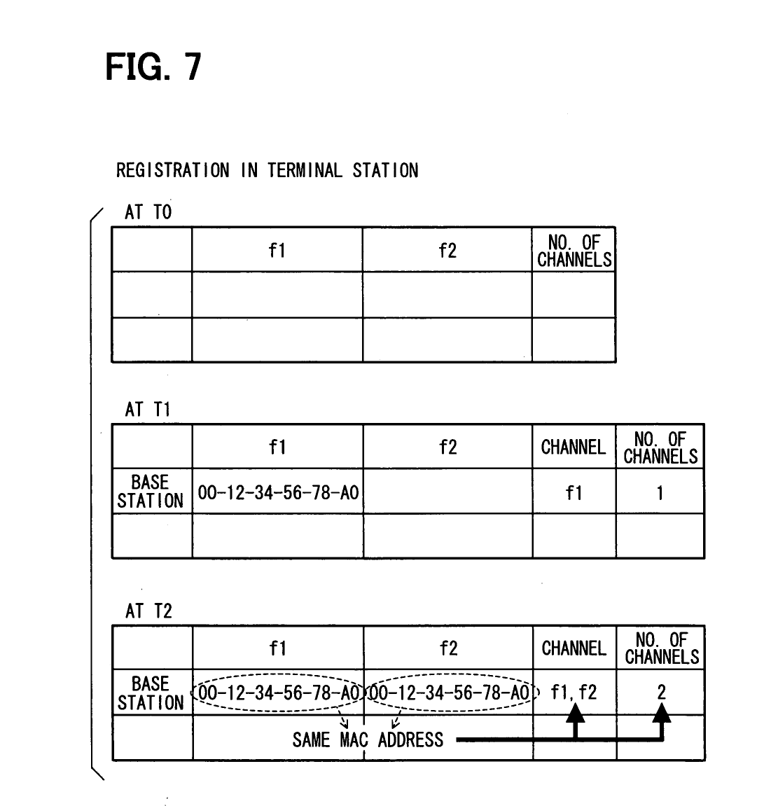

Specifically, as shown by an example of changes in the registration table in FIG. 7, the registration table is empty at time T0 immediately after power is applied to the terminal station 3, and when the terminal station 3 receives a beacon of the channel f1 at time T1, the MAC address of the base station 2 is registered with an association with the channel f1. A channel usable in the base station 2 is designated as the channel f1, and the number of usable channels is set to 1.

When the terminal station 3 receives a beacon of the channel f2 at time T2, the MAC address of the base station 2 is registered in the registration table with an association with the channel f2. Channels usable in the base station 2 are designated as the channels f1 and f2, and the number of usable channels is set to 2.

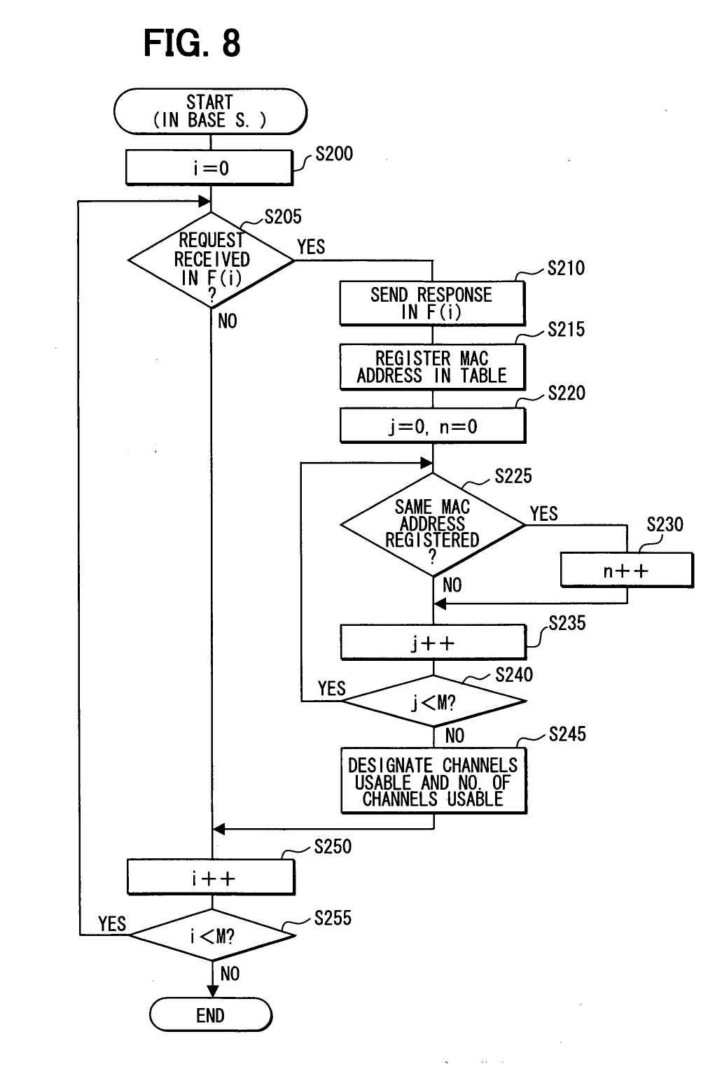

FIG. 8 is a flowchart showing the flow of designation processing (designation processing in the base station) performed by the channel designating part 46 of the base station 2. The channel designating part 46 of the base station 2 performs the processing when the receiving buffer 42 of the base station 2 receives a packet from a terminal (not shown) in wired connection to the base station 2, and the channel controller 43 transmits the packet.

As shown in FIG. 8, as a first step, the processing initializes channel identification number i associated with the channels f1 to fM to 0 (S200), selects a channel f(i) corresponding to the channel identification number i, and receives a connection request from a reception control part 451 corresponding to the channel f(i). The channels f1 to fM are respectively associated with channel identification numbers i from 0 to M−1.

The processing determines whether a connection request is received in a channel f(i) (S205), and when a connection request is not received (S205: No), immediately proceeds to S250 described later.

On the other hand, when a connection request is received in the channel f(i) (S205: Yes), the processing instructs the channel controller 43 to select the channel f(i) that received the connection request, and transmit a connection response to the connection request to the terminal station 3, using the channel f(i) (S210).

After registering a MAC address included in the connection request in a registration table (see FIG. 9) set in the channel registering part 47, with an association with the channel f(i) (S215), the processing initializes channel search number j associated with the channels f1 to fM and a value n for counting the number of channels to 0 (S220). The channels f1 to fM are associated with channel search numbers j of 0 to M−1, respectively.

The processing determines whether the same MAC address as the MAC address registered in the registration table in S215 is registered in the registration table, with an association with a channel f(j) corresponding to a channel search number j (S225).

When it is not registered in the registration table (S225: No), the processing immediately proceeds to S235 described later, while when registered (S225: Yes), the processing increments the count value n by one (S230), then increments the channel search number j by one (S235).

The processing determines whether the channel search number j is smaller than the number of channels usable in the base station 2 (that is, the number of channels=M) (S240), and when smaller (S240: Yes), proceeds again to the above-described S225.

On the other hand, when not smaller (S240: No), by registering usable channels and the number of the channels (count value n) in the registration table with an association with the terminal station 3, the processing designates channels usable in the terminal station 3 and the number of the channels (S245).

The processing increments the channel identification number i by one (S250), determines whether the channel identification number i is smaller than the number of channels usable in the base station 2 (that is, the number of channels=M) (S255), and when smaller (S255: Yes), proceeds again to the above-described S205, while when not smaller (S255: No), the processing ends.

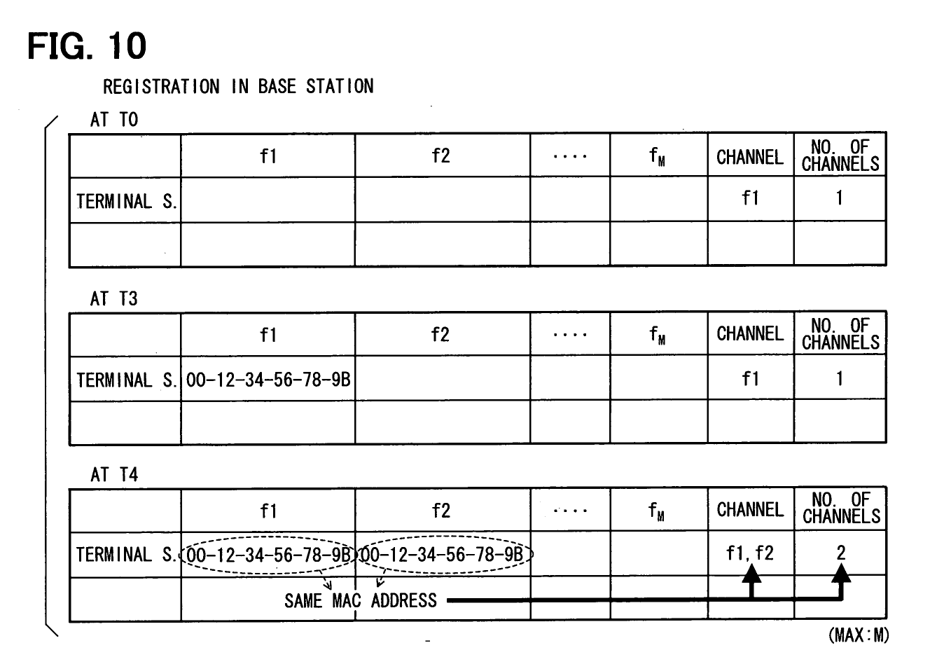

Specifically, as shown by an example of changes in the registration table in FIG. 10, the registration table is empty at time T0 immediately after power is applied to the base station 2, and when the base station 2 receives a connection request of the channel f1 at time T3, the MAC address of the terminal station 3 is registered with an association with the channel f1. A channel usable for communication with the terminal station 3 is designated as the channel f1, and the number of usable channels is set to 1.

When the base station 2 receives a connection request of the channel f2 at time T4, the MAC address of the terminal station 3 is registered in the registration table with an association with the channel f2. Channels usable for communication with the terminal station 3 are designated as the channels f1 and f2, and the number of usable channels is set to 2.

As has been described above, in the communication system 1, the base station 2 and the terminal station 3 register the identifier of a transmitting source included in a packet in the registration table, with an association with a channel through which the packet was received, and based on contents registered in the registration table, designate channels usable in the transmitting source and the number of the channels. Therefore, even when information indicating usable channels and the number of the channels is not added to a packet, these can be designated.

The terminal station 3 designates channels usable for communication with the base station 2 and the number of the channels when power is applied to the terminal station 3. Therefore, it can transmit and receive data to and from the base station 2 immediately after the power is turned on.

Since the base station 2 and the terminal station 3, during the above-described designation processing, switch channels to receive packets according to a predetermined order, usable channels can be sequentially confirmed.

Since the base station 2 performs the above-described designation processing when transmitting a packet, it can designate channels usable in the terminal station 3 and the number of the channels when transmitting a packet.

In the first embodiment, the RF part 7, the IF parts 61, the modems 51, and the reception control parts 451, S105 of the designation processing of the terminal station, and S205 of the designation processing of the base station function as a reception means. S115 of the designation processing in the terminal station and S215 of the designation processing in the base station function as an identifier registering means. S120 to S145 of the designation processing of the terminal station and S220 to S245 of the designation processing of the base station function as a channel designating means and a channel counting means. S150 of the designation processing in the terminal station and S250 of the designation processing in the base station function as a channel switching means.

In the first embodiment, S105 of the designation processing in the terminal station, and S205 of the designation processing in the base station function as reception steps. S115 of the designation processing in the terminal station and S215 of the designation processing in the base station function as an identifier registering step and an identifier registering procedure. S120 to S145 of the designation processing in the terminal station, and S220 to S245 of the designation processing in the base station function as a channel designating step, a channel designating procedure, a channel counting step, and a channel counting procedure.

In the first embodiment, the RF part 7, the IF parts 61, the modems 51, and the transmission control part 441 function as a transmission means.

### Second Embodiment

The following describes a second embodiment.

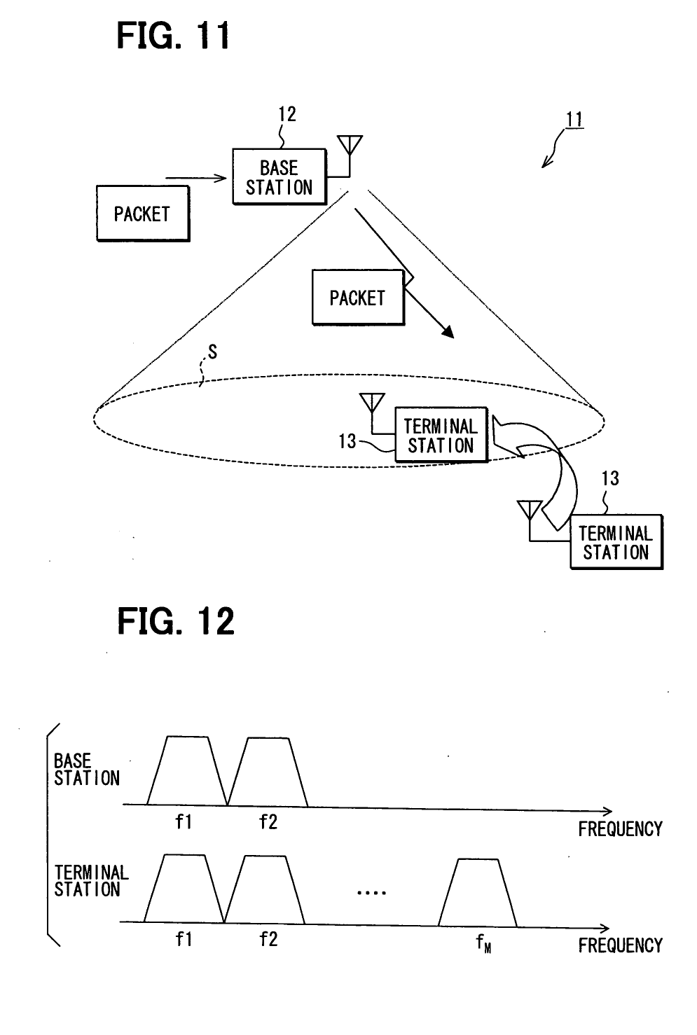

FIG. 11 is a block diagram showing an overall construction of a communication system 11 in the second embodiment.

As shown in FIG. 11, a communication system 1 includes a base station 12 and a terminal station 13. When the terminal station 13 enters a communication cell S of the base station 12, the base station 12 and the terminal station 13 mutually transmit and receive packets.

The base station 12 can use two channels f1 and f2, and the terminal station 13 can use M channels f1 to fM (see FIG. 12). Specifically, the base station 12 has the same internal construction as that of the base station 2 in the first embodiment, except that the respective numbers of transmission control parts 441, reception control parts 451, modems 51, and IF parts 61 are two (see FIG. 2). The terminal station 13 has the same internal construction as that of the terminal station 3 in the first embodiment, except that the respective numbers of transmission control parts 441, reception control parts 451, modems 51, and IF parts 61 are M (see FIG. 2).

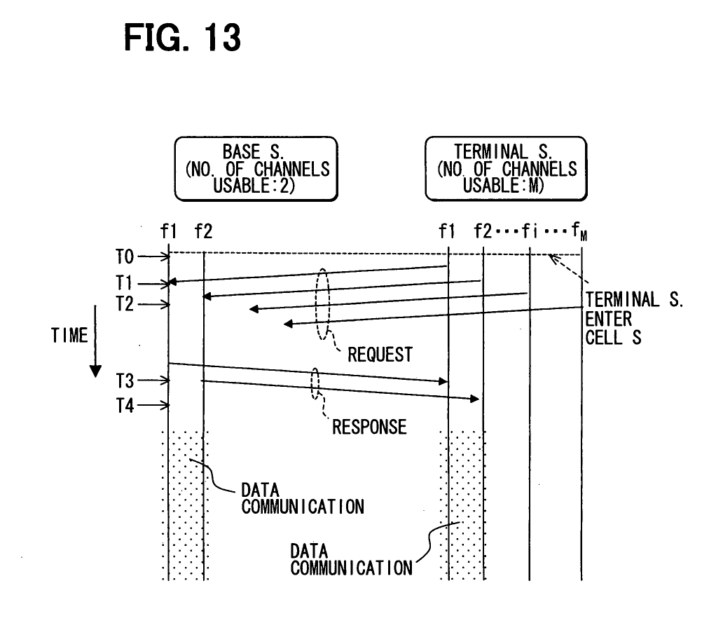

In the communication system 11, the base station 12 and the terminal station 13 perform communication according to a communication procedure shown in a sequence diagram of FIG. 13.

As shown in FIG. 13, in the communication system 11, when the terminal station 13 enters the communication cell S of the base station 12 (time T0), it sequentially switches the channels f1 to fM to transmit a connection request.

On the other hand, on receiving a connection request using the channels f1 and f2 (times T1 and T2), the base station 12 transmits a connection response to the terminal station 13, using the channels f1 and f2.

The terminal station 13 receives the connection response, using the channels f1 and f2 (times T3 and T4).

By this processing, communication between the base station 12 and the terminal station 13 is established, and the transmission and reception of data is started.

Determination processing performed in the terminal station 13 is the same as that in the first embodiment, except that the channels f1 to fM are sequentially switched to receive a connection response, and a connection request is not transmitted.

Determination processing performed in the base station 12 is the same as that in the first embodiment, except that the channels f1 and f2 are sequentially switched to receive a connection request.

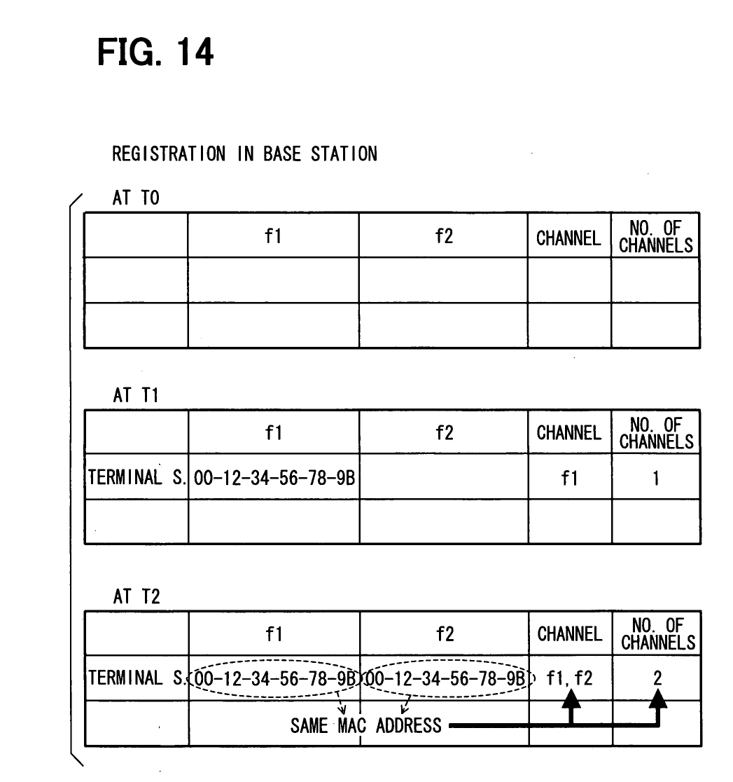

Specifically, in the base station 12, as shown by an example of changes in the registration table in FIG. 14, the registration table is empty at time T0 when the terminal station 13 enters the communication cell S, and when the base station 12 receives a connection request of the channel f1 at time T1, the MAC address of the terminal station 13 is registered with an association with the channel f1. A channel usable for communication with the terminal station 13 is designated as the channel f1, and the number of usable channels is set to 1.

When the base station 12 receives a connection request of the channel f2 at time T2, the MAC address of the terminal station 13 is registered in the registration table with an association with the channel f2. Channels usable for communication with the terminal station 13 are designated as the channels f1 and f2, and the number of usable channels is set to 2.

The communication system 11 as described above can produce the same effect as the communication system 1.

### Modification

Hereinbefore, embodiments of the present invention have been described. It goes without saying that the present invention is not limited to the above-described embodiments, and may be modified in various ways without departing from a technological scope of the present invention.

For example, in the above-described first and second embodiments, the base stations 2 and 12, and the terminal stations 3 and 13 are wirelessly connected to each other. However, they may be in wired connection to each other. In this case, the base stations 2 and 12, and the terminal stations 3 and 13 may designate usable channels and the number of the channels during wired connection.

Although in the first and second embodiments, a MAC address is used as an identifier for identifying a transmitting source of a packet, other identifiers such as an IP address may be used.

Although in the first and second embodiments, the base stations 2 and 12, and the terminal stations 3 and 13 sequentially switch multiple channels to transmit and receive packets, they may use all channels at the same time to transmit and receive packets.

Although in the first and second embodiments, a beacon, connection request, and connection response are used to designate usable channels and the number of the channels, other packets may be used to designate them.

Each or any combination of processes, steps, or means explained in the above can be achieved as a software unit (e.g., subroutine) and/or a hardware unit (e.g., circuit or integrated circuit), including or not including a function of a related device; furthermore, the hardware unit can be constructed inside of a microcomputer.

Furthermore, the software unit or any combinations of multiple software units can be included in a software program, which can be contained in a computer-readable storage media or can be downloaded and installed in a computer via a communications network. The computer-readable storage medium may be a flexible disk (FD), optical memory disk (MO), DVD, CD-ROM, Blu-Ray disk, HD-DVD, hard disk, memory card, or the like.

It will be obvious to those skilled in the art that various changes may be made in the above-described embodiments of the present invention. However, the scope of the present invention should be determined by the following claims.

What is claimed is:

1. A communication device comprising:
a receiving unit configured to receive, by using multiple channels, a packet including an identifier to identify a transmitting source;
an identifier registering unit configured to register the identifier included in the packet in a pre-specified storage area such that the registered identifier is associated with a channel through which the receiving unit receives the packet;
a channel designating unit configured to designate, when the identifier is registered in the storage area, a channel, which the registered identifier is associated with, as a channel usable for communication with the transmitting source indicated by the registered identifier; and
a channel counting unit configured to count, when the identifier is registered in the storage area, a number of channels, which the registered identifier is associated with, as a number of channels usable for communication with the transmitting source indicated by the registered identifier.

2. The communication device of claim 1, wherein
the identifier registering unit further registers (i) the channel usable designated by the channel designating unit and (ii) the number of channels usable counted by the channel counting unit, in the storage area such that the registered channel usable and the registered number of channels usable are associated with the registered identifier.

3. The communication device of claim 1,
wherein the identifier registering unit operates when the receiving unit receives the packet after a pre-specified time point.

4. The communication device of claim 3, further comprising:
a transmitting unit configured to transmit a packet by using multiple channels,
wherein the pre-specified time point is a time point when the transmitting unit transmits the packet.

5. The communication device of claim 1, further comprising:
a channel switching unit configured to sequentially switch channels used by the receiving unit in a pre-specified order after a pre-specified time point.

6. The communication device of claim 5, further comprising:
a transmitting unit configured to transmit a packet by using multiple channels,
wherein the pre-specified time point is a time point when the transmitting unit transmits the packet.

7. A communication system comprising a base station and a terminal station that transmit and receive packets to and from each other,
wherein at least one of the base station and the terminal station comprises the communication device of claim 1.

8. The communication system of claim 7,
wherein the identifier registering unit operates when the receiving unit receives the packet after a pre-specified time point.

9. The communication system of claim 8, wherein the communication device further comprises:
a transmitting unit configured to transmit a packet by using multiple channels,
wherein the pre-specified time point is a time point when the transmitting unit transmits the packet.

10. The communication system of claim 7, wherein the communication device further comprises:
a channel switching unit configured to sequentially switch channels used by the receiving unit in a pre-specified order after a pre-specified time point.

11. The communication device of claim 10, wherein the communication device further comprises:
a transmitting unit configured to transmit a packet by using multiple channels,
wherein the pre-specified time point is a time point when the transmitting unit transmits the packet.

12. A communication method comprising:
receiving by using multiple channels a packet including an identifier to identify a transmitting source;
registering the identifier included in the packet in a pre-specified storage area such that the registered identifier is associated with a channel through which the packet is received;
designating, when the identifier is registered in the storage area, a channel, which the registered identifier is associated with, as a channel usable for communication with the transmitting source indicated by the registered identifier; and
counting, when the identifier is registered in the storage area, a number of channels, which the registered identifier is associated with, as a number of channels usable for communication with the transmitting source indicated by the registered identifier.

13. A computer program product in a computer-readable medium for use in a communication device including a receiving unit for receiving by using multiple channels a packet having an identifier to identify a transmitting source, the computer program product comprising instructions for:
registering the identifier included in the packet in a pre-specified storage area such that the registered identifier is associated with a channel through which the receiving unit received the packet;
designating, when the identifier is registered in the storage area, a channel, which the registered identifier is associated with, as a channel usable for communication with the transmitting source indicated by the registered identifier; and
counting, when the identifier is registered in the storage area, a number of channels, which the registered identifier is associated with, as a number of channels usable for communication with the transmitting source indicated by the registered identifier.
